(19) United States
(12) Patent Application Publication
(10) Pub. No.: US 2004/0089962 A1
(43) Pub. Date: May 13, 2004

(54) Method for producing dental restoration elements

(76) Inventors: Michel Valery, Tarbes (FR); Jean-Dominique Soucaze-Soudat, Sainte Marie-De-Campan (FR)

Correspondence Address: YOUNG & THOMPSON, 745 SOUTH 23RD STREET 2ND FLOOR, ARLINGTON, VA, 22202

(21) Appl. No.: 10/472,161

(22) PCT Filed: Mar. 21, 2002
(86) PCT No.: PCT/FR02/00995

(30) Foreign Application Priority Data
Mar. 21, 2001 (FR) 01 04217

(51) Int. Cl. A61C 13/00

(52) U.S. Cl. 264/16; 264/219

(57) ABSTRACT

The invention relates to a method for producing high-geometric precision elements made from a neutral material. Using different types of prosthetic restoration, said elements are intended to fill the damage caused in teeth by dental caries or tissue alteration having other causes. The inventive elements are also intended to be used to produce high-precision dental crowns or other related dental devices. The method is characterised in that: a model (10), which is designed to fill the missing dental tissue that has been destroyed, is made either in vivo, updating and defining a new volume (2) that is bordered by healthy tissue and having a tapered wall, or in vitro, taking an impression in the mouth of a dental preparation using an impression compound, said impression then being cast in plaster, and updating and defining a new volume (2) using said positive plaster model; the measurements of said model (10) are then taken in 3D using a three-dimensional measuring apparatus (4, 15, 17) with light wavefront analysis and volume analysis which is carried out using shots, a projector (15) being positioned at an angle to a camera (17) and said projector (15) and camera (17) being mechanically and geometrically linked to a revolving platform (18) that is used to support the model by means of a frame (19) in order to obtain good triangulation; the data are processed electronically (12) to remodel the morsels of volume; the files are subsequently modified electronically to determine exactly the desired profile; and the final element to be implanted is machined with a digitally-controlled machine (6, 23, 24, 22).

The present invention relates to a method of producing high-geometric-precision implant elements, made from a neutral material and intended to plug by inlay or onlays the damage caused on hard dental tissues, or for the production of high-precision partial or full dental crowns, or for other implanted dental devices involving measurement in vivo or on models made out of wax or resins or other plastics materials modelled by a prosthetist.

In odontology, there exist currently various methods and mechanical devices intended to effect the filling of loss of dental tissue substance due to caries or to other causes, and for the creation of crowns or other devices.

At present in the case of caries or alteration of dental tissues, the dentist, in order to eliminate the carious or altered portion, removes the damaged elements by means of a drill or of an excavator and forms, using the aforementioned instruments, a housing, a preparation into which he introduces either a plastics material: amalgam with a mercury and silver base, resin, specific composite materials, or a metal casting obtained by the disposable wax method or ceramic and composite inlay after the recording of this preparation by impression compound, the two parts being produced by the dental prosthesis laboratory. The amalgams for odontological use have the disadvantage of employing materials of which the subsequent spread in the ambient surroundings is ill-controlled especially in relation to pollution due to mercury. In the case of composite resins, these have a significant rate of contraction giving rise to percolation, thus micro fissures start to form, altering the water-tightness of the filling and admitting septic liquids (saliva), which can lead to an alteration of the hard tissues of the tooth.

More recent equipment also exists for the production of inlays, onlays or ceramic crowns, for which the measurement is carried out by means of a video camera. Prior to the video analysis, the dentist must spread a white powder on the regions of the cavity to be analysed, and this in the mouth. This powder is subject to the laws of gravity and is more difficult to use in the maxilla than in the mandible. Next a video camera analyses the shades of grey in the region which has been scanned. Computer software evaluates the borders of the cavity, the different depths and it determines in this way the volume as a function of these shades of grey. Next the operator delimits electronically by means of a mouse, the lateral borders of the floor of the cavity and the juxta-gingival limits of the tooth in order to produce the desired type of dental reconstruction. This process is not very accurate in view of the measurement technology used and it has numerous disadvantages. The analyses of shades of grey give a poor level of precision, especially in relation to the shaded areas which are totally inaccessible to analysis by this process. Then the lateral limits of the site of the reconstruction are not precise limits of the defined site but a simple site given by the operator without taking account of the aspects of roughness and of the precise location in space of the preliminary work carried out by the dentist. The peripheral juxta-gingival limits of the tooth are not well-defined either for they are determined in an arbitrary manner by the operator. The proximal and occlusal surfaces come from a computer data bank which holds in its memory numerous tooth profiles. As regards the geometric location in space, there is no fixed position reference link in the space between the video camera used for taking the shots and the cavity in question, for these shots are taken with a hand-held camera. Nor is account taken of the profiles of the antagonist teeth which will be positioned exactly opposite the implanted element.

Other systems exist of digitisation or of recording of the contours of prosthetic preparation with a recording probe fitted with a simple sensor or with a sapphire needle; the preparation being mounted on a turntable, it is sometimes centred by a laser diode. This process requires physical contact between the sensor or the sapphire needle and the preparation which excludes recording of materials of weak mechanical resistance, soft materials in effect.

The present invention proposes to remedy these disadvantages by proposing a method of producing high-geometric-precision implant elements made from a neutral material and intended to fill by means of different types of reconstruction the damage caused by caries or alteration of dental tissues, or intended for the production of high-precision partial or full dental crowns, or other implanted dental devices, involving direct or indirect measurements, which are transmitted or not to a prosthetic technician by electronic means.

To this end and more precisely, the present invention relates to a method of producing high-geometric-precision implant elements made from a neutral material and intended to fill by means of different types of prosthetic reconstruction the damage caused in the teeth by dental caries or alteration of tissues having other causes, or intended for the production of high-precision dental crowns, or other implanted dental devices, a method characterised in that:

a model which is designed to fill missing dental tissue which has been destroyed is produced, either in vivo by updating and defining a new volume which is bordered by healthy tissue and has the shape of a tapered wall, or in vitro by taking an impression in the mouth of a dental preparation using an impression compound, this impression then being cast in plaster and, from this positive plaster model, updating and defining a new volume,

then a measurement of this model is taken in 3-D by means of a three-dimensional measuring apparatus with light wavefront analysis, a volume analysis carried out by means of shots, a projector being positioned at an angle to a camera, the projector and the camera being mechanically and geometrically linked to a revolving platform that is used to support the model by means of a frame in order to obtain a good triangulation,

followed by electronic processing to remodel the sections of volumes among themselves,

then an electronic modification of the files to determine exactly the desired profile,

then a machining of the final element to be implanted with a digitally-controlled machine.

The advantages obtained are: production of implant parts of a neutral nature which are non-polluting both while they are in the mouth and when they are removed, a high degree of precision in the finished element which can be close to two-hundredths of a millimetre, speed and ease of implementation.

This method can be implemented in two ways, especially in odontology: either based on a model made in the mouth (in vivo), or in vitro: from a conventional dental impression, the model is produced directly in the laboratory.

The present invention will be better understood by reading the detailed description which follows with reference to the annexed drawings and giving by way of example, which is indicative but in no way restrictive, one embodiment of the invention.

On the drawings:

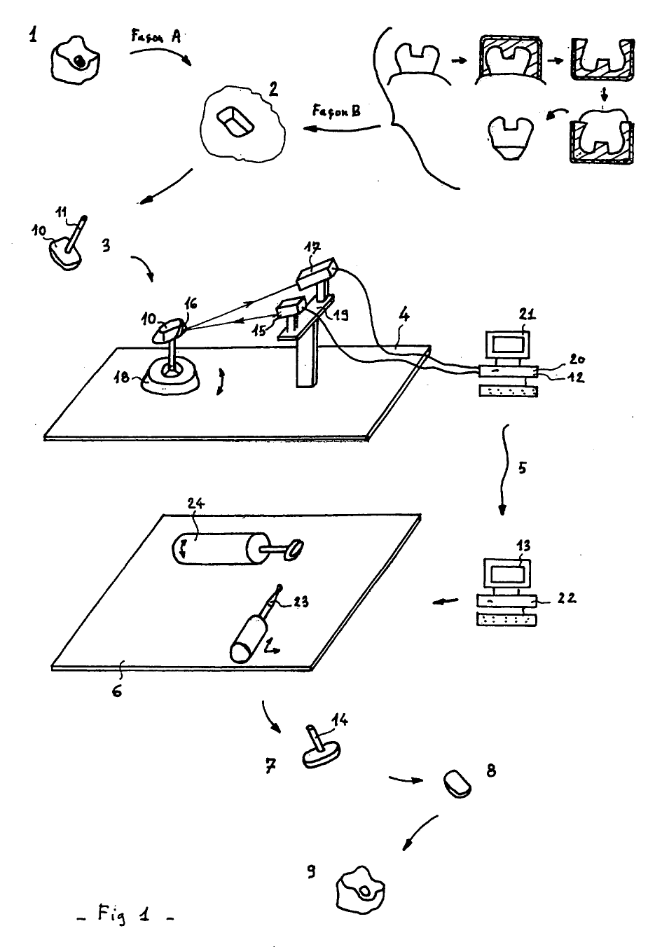

FIG. 1 represents, on a reduced scale, a schematic view of the series of operations to be carried out during the implementation of the method.

With reference to FIG. 1, the method is applicable in general to the production of a plurality of elements intended to plug the damage caused in the teeth of mammals.

In order to implement the method, it is necessary in the first place to construct a model aimed at filling the loss or losses of substance from the dental organ or organs. This model may be produced in two ways, either directly in the mouth, mode A, or in the prosthesis laboratory, mode B, after taking an impression of the loss of substance by means of a conventional material (alginate, silicone or other). This impression will be processed in the prosthesis laboratory in such a way as to obtain a positive mould.

In the first mode A, the dentist, in operation 1 begins by removing with a drill or an excavator, the defective dental tissues in order to update and define a new volume 2 bordered by healthy tissues and having the shape of a tapered wall. Up to that point, this work requires the production of a cavity with or without counter-taper. With the method according to the invention, a counter-taper is banned.

The second mode B consists in taking an impression in the mouth of the dental preparation by using conventional impression compound and in a conventional and customary method in dentistry, then this impression is cast in plaster and, from this positive model, the first, already described, mode is rejoined to arrive at the new volume 2. The practitioner ought also to take an antagonist impression with the preparation in order to be able manually to create the occlusal surface of the different models.

Based upon the new volume 2, a model 3 is produced using opaque photo-hardening resin 10 in which is housed, prior to complete hardening, a manipulating rod 11. After final hardening, the assembly is withdrawn, the rod 11 being immovably attached to the hardened opaque resin 10, which resin is a model of the volume to be filled.

The assembly of rod 11 and resin model 10 is next positioned on the revolving platform 18 of a machine 4 for measuring in three dimensions by means of light wavefront analysis, for example an “OptoTOP” machine.

The “OptoTOP” machine uses a system of 3-D metrology in which the shots are recorded and analysed in three dimensions. The operation of the “OptoTOP” system is based on a principle of optical triangulation: topometry which uses a projection of structured and phase-offset white light.

For this purpose, a luminous rectangular pattern constructed from a plurality of luminous bands is projected on the model 10 of which the volume has to be measured. The luminous bands 16 are projected at an angle on the model and they match perfectly the shapes of the model. Machine 4, via a CCD camera 17 positioned laterally in relation to the projector 15, records quasi-simultaneously two images, the one conventional in two dimensions and the second which is that of the deformed bands, projected upon the model 10 to be measured. The projector 15 which generates the bands 16 is positioned at an angle to the camera 17, the projector and the camera are mechanically and geometrically linked to the revolving platform which supports the model 18 by means of a frame 19, in order to obtain a good triangulation. From a computer unit 21, comparison software 12 next analyses the two images in order to calculate the volume observed by the camera, from a certain angle. The revolving platform 18 allows the exposure in succession of all the surfaces of the model to the light beams. A plurality of measurements are taken. These measurements are then converted into electronic files which describe the structure of the final volume of the model, either in the form of triangles (.stl format), or in the form of clouds of x y z points (ASCII format). These electronic files are then ready to be used by other software.

These files are then either compared with other files or manually modified by means of software for correcting or refreshing volume 20, for example Polyworks software. The file produced from these modifications and characterising the definitive shape to be obtained is then either processed on the spot on a linked digitally-controlled machine 6 or it is sent via a computer network 5 to a computer unit 13 which controls this same digitally-controlled machine 6, which is not linked, situated elsewhere in another geographical location. Once the electronic files described above have been received by this machine 6, the machine is in a position to cut by means of drills 23 or other machine tools controlled by the machine and its software, a sized part 24 having at the end of the operation volume characteristics most closely approaching those of the model produced initially.

In this spirit, one of three known types of digitally-controlled machine can be used, for example: a digitally-controlled machine operating on three axes, four axes or five axes. When using a digitally-controlled machine on three axes, it will be necessary to proceed by reversal of the part to be machined. When using a digitally-controlled machine on four axes, in circular mode, the machining of the sized part to be machined 24 can be carried out either on the generator, or on the axis of rotation, or on the helix. When using a digitally-controlled machine on five axes, the combination of the five axes of the machine is used. The integrated software 22 in these different machines, for example the “Maquette Volume” software, can if required integrate additions of one or more square or rectangular fasteners 14 and remove traces of the rod 11 of the model.

The product of this machine then is a part 7 approaching the required volume with the addition of one or more fasteners 14 intended to physically maintain the definitive volume of the output part 24 of which it is the product. This fastener or these fasteners 14 are destroyed by the drill either by the dentist or by the prosthetist to obtain finally a part 8 which is the counterpart of the volume to be filled. This part 8 is then inserted by simple gluing into the initial volume 2. The tooth 9 is thus reconstructed.

On the same principle, the method can be applied also to the production of prosthetic dental crowns produced from the second mode B described above. Starting with the positive model, firstly a 3-D recording is produced of the stump, which may or may not be coated with a thickness-compensating varnish. Secondly, after intervention by the dental prosthetist, and presentation of the antagonist moulds, a recording of the cap realised in hard or soft, opaque material is produced.

The 3-D recording software 12 already mentioned then produces, automatically or otherwise, the geometric link between the measurements of the stump and those of the model, created by the prosthetist.

At the end of this process, a virtual volume is obtained which defines the intrados and the extrados of the final cap or crown, to be machined.

For the bridges which are an assembly of caps and bridging pieces, the method uses again all the elements described above for the models and crowns, these volumes being linked.

The present invention has the advantage that a high degree of precision in the implanted elements is obtained, with the possibility of an effective neutrality of these elements, made out of diverse materials such as ceramics, marble, ordinary stone, precious stone, coloured material etc., with a high degree of compatibility between the contacts of the surfaces of the antagonist teeth and adjacent teeth.

It goes without saying that the invention has been described above by way of preferred example, which is indicative but not restrictive, and that it is possible to introduce any equivalence in its constituent elements without departing from the framework defined by the annexed claims.

1. Method of producing high-geometric-precision implant elements made from a neutral material and intended to fill by means of different types of prosthetic reconstruction the damage caused in teeth by dental caries or by alteration of tissues having other causes, or intended to produce high-precision dental crowns, or other implanted dental devices, a method characterised in that:
a model (10) which is designed to fill the missing dental tissue which has been destroyed is made, either in vivo updating and defining a new volume (2) bordered by healthy tissue and having the shape of a tapered wall, or in vitro by taking an impression in the mouth of a dental preparation using an impression compound, this impression then being cast in plaster and, from this positive plaster model, updating and defining a new volume (2),
then a measurement of this model (10) is taken in 3-D by means of a three-dimensional measuring apparatus (4, 15, 17) with light wavefront analysis, a volume analysis carried out by means of shots, a projector (15) being positioned at an angle to a camera (17), the projector (15) and the camera (17) being mechanically and geometrically linked to a revolving platform (18) which provides support to the model by means of a frame (19) in order to obtain a good triangulation,
followed by electronic processing (12) in order to remodel the sections of volumes between themselves,
then electronic modification of the files to determine exactly the desired profile,
then machining of the final element to be implanted with a digitally-controlled machine (6, 23, 24, 22).

2. Method according to claim 1, characterised in that the volume analysis carried out by means of a shot or shots includes the use of a luminous rectangular pattern constructed from a plurality of luminous bands projected on the model by the projector (15).

3. Method according to claim 2, characterised in that it consists in projecting the said angled luminous bands on the model.

4. Method according to any one of claims 1 to 3, characterised in that the material used is a neutral material of ceramic type, natural marble type, artificial plastic type, or a coloured decorative material.

5. Method according to any one of claims 1 to 4, characterized in that it includes the machining of multiple prosthetic elements linked to one another, conventionally produced by the disposable wax method.

6. Utilisation of the method according to any one of claims 1 to 5, for the production of inlays by means of taking a simple impression.

7. Utilisation of the method according to any one of claims 1 to 5, for the production of partial or full crowns.
